(19) United States
(12) Patent Application Publication
(10) Pub. No.: US 2013/0050436 A1
(43) Pub. Date: Feb. 28, 2013

(54) METHOD AND SYSTEM FOR REPRODUCTION OF 3D IMAGE CONTENTS

(71) Applicant: Klaus Illgner-Fehns, Munich (DE)

(72) Inventor: Klaus Illgner-Fehns, Munich (DE)

(73) Assignee: INSTITUT FUR RUNDFUNKTECHNIK GMBH, Munich (DE)

(21) Appl. No.: 13/582,002

(22) PCT Filed: Feb. 28, 2011
(86) PCT No.: PCT/EP2011/052918

§ 371 Date: Sep. 12, 2012

(30) Foreign Application Priority Data
Mar. 1, 2010 (DE) 102010009737.3

(51) Int. Cl. H04N 13/00

(52) U.S. Cl. 348/47; 348/E13.015

(57) ABSTRACT

To allow for a larger selection of viewpoints for the viewer during the reproduction of 3D image contents, it is proposed to compute the two stereoscopic images from the image signals of recording cameras (101, 102, 103), which record images of an object (1) to be reproduced from different viewpoints of a monoscopic position. The stereoscopic images are computed with an image viewpoint, which correspond to the viewing angle of a hypothetical viewer (400) in the central axis of the monitor screen (304). A change of the actual viewing position with regard to the central axis is signalized to a processing unit (301), which computes the two stereoscopic images with image viewpoints changed accordingly.

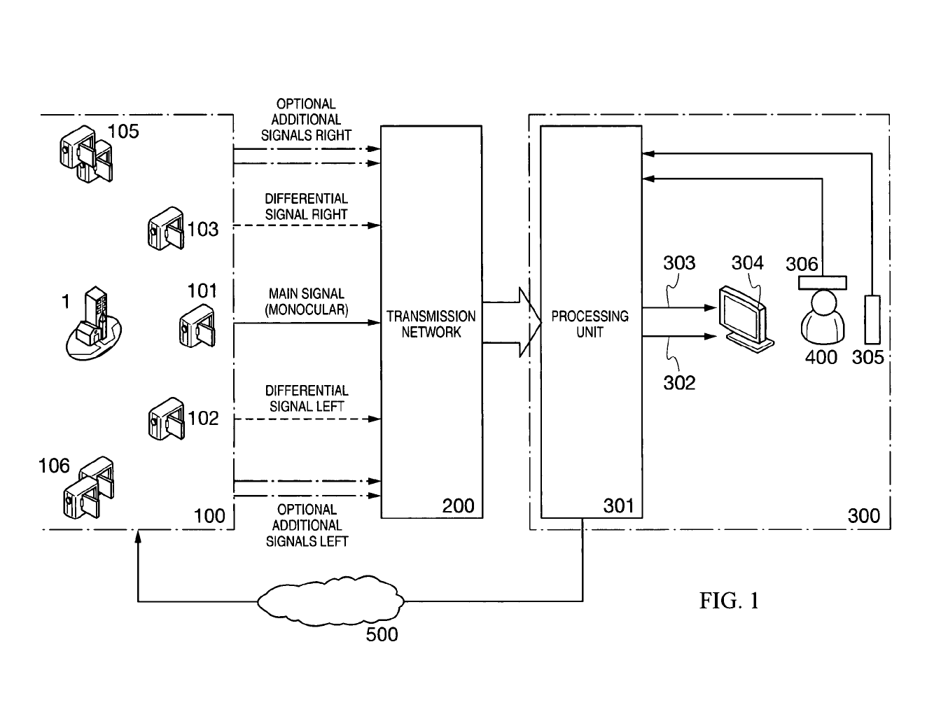

The Invention relates to a method and a system for reproduction of 3D image contents. Methods and systems of this kind are generally known.

The basis for the presentation of 3D image contents in the mass market is the technology of modern flat monitor screens, which nowadays are offered by nearly all producers of television receivers. In parallel, 3D movies are increasingly produced in the studios of the large movie producers. The gaming industry also puts emphasize on 3D technology in order to increase realism of the gaming experience.

Modern flat monitor screens allow for both high spatial image resolution (for example 1920 pixels per line at 1080 lines per complete image) and a high temporal image resolution up to an image frequency of 200 Hz. For the spatial image resolution in particular, even higher resolutions are to be expected in the near future. Prototypes of 4k displays have been presented at the IFA 2009 by the company Samsung. The image frequency will be rising as well. 400 Hz is a subject under discussion. For the presentation of 3D image contents, a stereoscopical kind of display currently prevails. The stereoptical perception is created by presenting the left and the right eye two different images of the same scene. Passive systems make use of the high spatial resolution of the monitor screens to display the two images simultaneously. The separation of the simultaneously displayed stereoscopic images takes place using passive polarization filters, which are placed in front of the monitor screen. Alternatively, active systems, which present the left and the right image temporally alternating on the monitor screen, are applied. Shutter glasses synchronized with to the image frequency separates the images for the left and the right eye.

Independent of the known types of display of the left and the right image, the viewer fundamentally only sees one perspective of the scene, namely independent of the viewing angle, from which the viewer sees the monitor screen. For a viewer, a change of the perspective is no more possible than the simultaneous presentation of different perspectives for multiple simultaneous viewers.

The technical problem to be solved by the invention is to provide a method and a system for the reproduction of 3D image contents that offer a larger selection of the perspective to the viewer.

For a method, this technical problem is solved by the features of the patent claim 1 or of the coordinated claim 6.

Advantageous embodiments and developments of the method according to the invention follow from the dependent claims 2 to 5.

For a reproduction system, the solution of the technical problem follows from the features of the coordinated patent claim 7.

Advantageous embodiments and developments of the reproduction system according to the invention follow from the dependent claims 8 to 11.

In the following, the invention is described in more detail by means of the drawings. The only FIGURE shows a schematic system of a system for recording 3D image contents according to the state of the art and for reproduction of 3D image contents according to the invention.

The system 100 shown in the left half of the FIGURE is used for recording images of an object 1 from three viewing angles, each of a monoscopic position. Accordingly, the system 100 comprises three cameras 101, 102, and 103, of which the main camera 101 is oriented centrically towards the object 1 and the left and the right side cameras 102, 103 are oriented laterally towards the object 1. The video signal of the central main camera 101, which is also suitable for a backward compatible, monoscopic display, is encoded as main signal (mono) and transferred via a suitable transmission network 200, for example a broadcast or a multicast network, to a reproduction unit 300. From the video signals of the left and the right neighboring cameras 102, 103, left and a right differential signals are generated with respect to the main signal of the central main camera 101 prior to a transmission. The generated differential signals are encoded and transmitted to the reproduction unit 300 via the transmission network 200.

The reproduction unit 300 comprises a processing unit 301 that, for the display on a monitor screen 304, computes the image signals 302, 303 of two stereoscopic images of the object 1 from the received main signal and the two received differential signals. The display may be made for any active of passive 3D monitor screen system. The stereoscopic images are computed with an image viewpoint that corresponds to the viewing angle of a hypothetical viewer 400 in the central axis of the monitor screen 304.

For instance, in case the viewer 400 of the monitor screen 304 actuates the right/left arrow buttons on his remote control 305, he signalizes the processing unit 301 a change of the viewing position. From the three available images of the cameras 101, 102, and 103, the processing unit 301 computes the stereoscopic images, which are appropriate for the signalized new viewing position, with image viewpoints changed accordingly. Thereby, on the monitor screen 304, stereoscopic images are presented to the viewer 400 having a viewpoint corresponding to his selected viewing position, whereby a larger selection of viewpoints are offered to the viewer.

In the case that the viewing angle of the viewer 400 leaves the range that may be computed by the processing unit 301 using the three available images of the cameras 101, 102, and 103, according to a development of the invention, the further camera positions required for this purpose may be retrieved “on demand” and individually by the processing unit 301, for example via an internet connection 500. For this purpose, additional cameras 104, 105 are provided at the system 100 for recording further lateral recording viewpoints of the object. The additional “on-demand” video signals of the cameras 104, 105 are encoded just as the main and the differential signals and, for instance, transmitted via the transmission network 200. However, other types of transmission of the additional “on demand” video signals are possible, for example via the internet 500.

Another possibility for signaling a change of the viewing position is the use of a head tracker 306, which determines the head turn and the head position of the viewer 400 in front of the monitor screen 304. In general, the viewer sits more or less immobile in front of the monitor screen 304 of the television or of a games console so that the sector of possible viewing angles is relatively small. On the contrary, a completely different way of perception is possible, if the viewer may assume any positions within a much larger sector, for example by moving in front of the monitor screen 304. The current viewing angle captured by means of the head tracker 306 is signaled to the processing unit 301 as a head tracker signal. In accordance with the head tracker signal, the processing unit 301 computes the appropriate viewpoint of the two stereoscopic images reproduced on the monitor screen 304 from the available camera positions. In this way, the viewer 400 may virtually move around the scene displayed on the monitor screen 304. The head tracker 306 may be arranged at the head of the viewer 400 or may be installed in (shutter) glasses used by the viewer 400. Alternatively, the head position of the viewer 400 may be captured using a camera, which, for example, is arranged at the monitor 304 and oriented towards the viewer 400.

For the simultaneous presentation of different viewing positions for multiple viewers, an active shutter system with glasses that are synchronized with the increased full image frequency is required. At the same time, an active shutter system offers the advantage of a full HDTV spatial resolution. Modern flat screen monitors may, as mentioned at the outset, display up to 200 images per second.

Because, as is well known, a fluent, flickerfree perception is adequate already at 50 Hz full image frequency, at least two independent viewing positions may be displayed using a 200 Hz monitor screen. In case an image is suitable both for an eye of one viewer and for an eye of another viewer, the number of simultaneously displayable viewing positions increases. Another increase of the number of independent viewing positions is possible by means of combining the passive (spatial) and active (temporal) separation of images, however, along with a reduction of the spatial resolution.

1. A method for reproduction of 3D image contents, in which stereoscopic images of the same scene are presented to the left and the right eye of a viewer (400), wherein the two stereoscopic images are computed from the image signals of recording cameras (101, 102, 103), which record images of an object (1) to be reproduced from different viewpoints of a monoscopic position, and the stereoscopic images are computed with an image viewpoint that corresponds to the viewing angle of a hypothetical viewer (400) in the central axis of the monitor screen (304), and a change in the actual viewing position with regard to the central axis is signalized to a processing unit (301), which computes the two stereoscopic images with image viewpoints changed accordingly.

2. The method according to claim 1, wherein the two stereoscopic images are computed from the two image signals of a central recording camera (101) and at least two left and right neighboring cameras (102, 103).

3. The method according to claim 1, wherein images of the object (1) from additional lateral recording viewpoints are retrieved via an internet connection (500) and used for the computation of additional image viewpoints of the stereoscopic images.

4. The method according to claim 1, wherein a change of the actual viewing position with respect to the central axis is signalized to a processing unit (301) by means of a remote control (305).

5. The method according to claim 1, wherein the head turn and the head position of the viewer is determined by a head tracker signal and signalized to the processing unit (301), which, according to the head tracker signal, computes the viewpoint of the stereoscopic images corresponding to the actual head pose from the available camera positions.

6. A method for reproduction of 3D image contents, in which stereoscopic images of the same scene are presented to the left and the right eye of a viewer (400), wherein at least two stereoscopic images from different recording viewpoints are displayed on a flat screen monitor (304) with an increased full image frequency of 200 Hz in a temporally alternating way, the at least two stereoscopic images being viewed through shutter glasses that are synchronized with the increase full image frequency.

7. A system for reproduction of 3D image contents, wherein stereoscopic images of the same scene are presented to the left and the right eye of a viewer (400), the system comprising a processing unit (301) for computing the two stereoscopic images from the image signals of recording cameras (101, 102, 103) recording images of an object (1) to be reproduced from different viewpoints, wherein the stereoscopic images are computed by the processing unit (301) with an image viewpoint that corresponds to the viewing angle of a hypothetical viewer (400) in the central axis of the monitor screen (304), and comprising a signaling unit (305; 306) for signaling a change of the actual viewpoint with regard to the central axis to a processing unit (301), the processing unit computing the two stereoscopic images with image viewpoints changed accordingly.

8. The system according to claim 7, wherein the processing unit (301) computes both stereoscopic images from the image signals of a central recording camera (101) and at least two left and right neighboring cameras (102, 103).

9. The system according to claim 7, wherein, for the computation of additional image viewpoints of the stereoscopic images, the processing unit (301) uses images of the object (1) from additional lateral recording viewpoints.

10. The system according to claim 7, comprising a remote control (305) for signaling a change of the actual viewing position with regard to the central axis to a processing unit (301).

11. The system according to claim 7, comprising a head tracker (306) for signaling the head turn and head position of the viewer to the processing unit (301), which, according to the head tracker signal, computes the viewpoint of the stereoscopic images corresponding to the actual head pose from the available camera positions.
